(19) United States
(12) Patent Application Publication
(10) Pub. No.: US 2004/0194829 A1
(43) Pub. Date: Oct. 7, 2004

(54) Differential pressure valve employing near-balanced pressure

(76) Inventors: LeNoir E. Zaiser, Naples, FL (US); Kevin Confoy, Naples, FL (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/666,115

(22) Filed: Sep. 19, 2003

Related U.S. Application Data
(60) Provisional application No. 60/412,056, filed on Sep. 19, 2002.
(60) Provisional application No. 60/412,055, filed on Sep. 19, 2002.

(51) Int. Cl. F16K 31/126

(52) U.S. Cl. 137/544

(57) ABSTRACT

A differential pressure valve is used to deliver a medical gas such as oxygen to a patient. A movable slave diaphragm operates to open and close a gas passageway in response to the patient's inhalations. In particular, the slave diaphragm opens and closes a nozzle that is pressurized by stored oxygen in a gas reservoir. The diaphragm is pneumatically controlled in response to the patient's inhalation. The nozzle is sized so that the forces exerted on the diaphragm on the nozzle side of the diaphragm nearly balance the forces exerted on the opposing (timing gas chamber) side of the diaphragm. Furthermore, the nozzle includes a filter element.

### RELATED APPLICATION

This application claims the benefit of U.S. Provisional Application No's. 60/412,056, filed on Sep. 19, 2002, and 60/412,055, filed on Sep. 19, 2002, the entire teachings of which are incorporated by reference.

### BACKGROUND

Medical gas regulators are used to supply a patient with a regulated flow of a gas, such as oxygen. The gas is supplied by a source of compressed gas, such as from a supply tank, which has its pressure reduced to a low pressure (e.g. 22 PSI) for delivery to the patient. Typical oxygen regulators employ a back-pressure piston to supply a continuous flow of that low pressure oxygen to the patient. Much of that oxygen is wasted because it is not inhaled by the patient.

To reduce the amount of wasted oxygen, oxygen-conserving regulators have been developed. These regulators tend to limit the oxygen flow to periods of inhalation. The oxygen flow can be controlled electronically or pneumatically.

In pneumatic conserving regulators, a reservoir coupled to the oxygen source holds a supply of oxygen for delivery to the patient. Delivery of the oxygen is controlled by a slave diaphragm that separates the reservoir from a timing gas chamber. The slave diaphragm seals the opening to a delivery nozzle when the patient is not inhaling and releases the seal from the nozzle opening when the patient inhales. The slave diaphragm is made from a flexible material and is generally pressurized toward the closed position. Opening of the slave diaphragm is responsive to the patient's inhalation.

### SUMMARY

In accordance with the invention, a differential pressure valve operates with nearly-balanced pressure. The valve can be particularly used in medical gas conserving devices, including oxygen conserving devices.

In accordance with one aspect, embodiments of the invention can include a pneumatic valve. A particular pneumatic valve can comprise a valve body formed to include a delivery passageway between an inlet and an outlet, a supply reservoir coupled to the inlet, and a diaphragm valve member movable to open and close the delivery passageway. The interface between the diaphragm and the delivery passageway is substantially greater than 0.55% of the surface area of the diaphragm. In a particular embodiment, the interface can be about 17% of the surface area of the diaphragm. The delivery passageway can be used to deliver a gas, such as oxygen.

More particularly, the delivery passageway can include a nozzle that is sealed by the diaphragm to close the delivery passageway. The delivery passageway can include a filter element housed within the nozzle. The filter element can have a porosity of about 20 μm.

In accordance with another aspect, embodiments of the invention can include a valve. A particular valve can comprise a nozzle having a head for delivering a pressurized supply of a medium to a delivery outlet, a control chamber capable of being pressurized to a working pressure (e.g. 22 PSI) and depressurized, and a diaphragm disposed between the nozzle head and the control chamber. More particularly, the surface area of the diaphragm communicating with the nozzle head is substantially greater than 0.55% of the surface area of the diaphragm in communication with the control chamber, such as about 17%.

In addition, the nozzle can be coupled to a filter element. The filter element can be fabricated from sintered bronze, with a uniform porosity of about 20 μm.

In accordance with another aspect, embodiments of the invention can include a valve for supplying a flow of a gas. A particular valve can comprise a gas reservoir for storing a supply of gas at a delivery pressure, an outlet for delivering the supply of gas from the gas reservoir, a nozzle having a head disposed between the gas reservoir and the outlet, a diaphragm for actuating the flow of gas from the nozzle head to the outlet, and a timing gas chamber for controlling the diaphragm, the diaphragm sealing the nozzle head when the timing gas chamber is pressurized and releasing from the nozzle head when the timing gas chamber is depressurized.

The nozzle can be pneumatically coupled to the gas reservoir so that gas in the nozzle head is pressurized to the delivery pressure. The nozzle head can include a filter element. The filter element can be made from sintered bronze and have a uniform porosity of about 20 μm.

The force exerted on the diaphragm by the pressurized timing gas chamber is substantially balanced by an opposing pneumatic force on the diaphragm. The ratio of the opposing pneumatic force to the time gas chamber force being less than 1:2.4, such as at most about 1:2.0.

The gas reservoir and the timing gas chamber can be pressurized to the delivery pressures.

In accordance with yet another aspect, embodiments of the invention can include a gas flow device for delivering a regulated flow of a gas. A particular gas flow device can comprise a housing connectable to a source of compressed gas and having an delivery port for delivering a regulated flow of the gas, a gas flow path within the housing from the source of compressed gas and the delivery port, and a nozzle disposed in the gas flow path, wherein the nozzle includes a filter element. The filter element can be made from sintered bronze and have a uniform porosity. The gas flow path can include a pneumatic valve, where the nozzle forms a part of the valve

### BRIEF DESCRIPTION OF THE DRAWINGS

The foregoing and other objects, features and advantages of the Differential Pressure Valve Employing Near-Balanced Pressure will be apparent from the following more particular description of particular embodiments of the invention, as illustrated in the accompanying drawings in which like reference characters refer to the same parts throughout the different views. The drawings are not necessarily to scale nor are all assembly features shown, emphasis instead being placed upon illustrating the principles of the invention.

FIG. 1 is a schematic of a typical demand regulator system.

FIG. 2 is a foreshortened cross-sectional schematic of a particular prior art slave valve configuration.

FIG. 3 is a foreshortened cross-sectional schematic of another particular prior art slave valve configuration.

FIG. 4 is a foreshortened cross-sectional schematic of a particular near-balanced pressure system in accordance with the invention.

### DETAILED DESCRIPTION

There are two types of medical gas conservers in common use, electronic and pneumatic. Of the pneumatic types, there are two types of systems: single-lumen and dual-lumen.

Dual-lumen devices use a cannula with two separate hoses for connecting to the conserver. Depending on the design of the cannula, each hose either serves one or both nostrils of the patient. The conserver likewise has two cannula hose ports. A sensing or pilot port is used exclusively for sensing the vacuum caused by patient inhalation. A slave or delivery port is used exclusively for delivery of oxygen to the patient.

When the patient inhales, oxygen is delivered by the delivery port through a delivery hose until inhalation ends. Because the two hoses of the cannula do not intermingle, the conserver is able to deliver oxygen the entire time the patient is inhaling. Therefore, dual-lumen conservers are commonly called “demand” conservers.

In comparison, single-lumen conservers use only a single cannula hose that serves both nostrils, which is coupled to a single port on the conserver. When no oxygen is flowing through the tube, the conserver can detect when the patient inhales, and oxygen delivery begins. However, once oxygen begins to flow through the hose, the device will no longer be able to sense when inhalation ends. Therefore, the device is constructed to stop the flow of oxygen after a predetermined amount of time, regardless of the patient's breathing pattern. There are some pneumatic devices that work this way, and all electronic devices work this way. These conservers are called “pulse” conservers, as they typically give a large pulse of oxygen and then shut themselves off and wait for the next breath.

Dual-lumen conservers have the advantage of much better performance under all breathing conditions, meaning they deliver the correct amount of oxygen for the patient and work well with the widest variety of breathing patterns. Also, dual-lumen devices can have continuous flow at all settings if required, whereas single-lumen devices have only a single continuous flow setting. Single-lumen conservers have the advantages of a simpler (and cheaper) cannula hose, and because they only deliver a pulse of oxygen, these conservers can have a higher conservation ratio (many people believe that oxygen delivered at the end of inhalation is wasted because it does not get to the lungs before being exhaled). However, by controlling the rate of flow after the initial burst of oxygen, a dual-lumen device can be manufactured to conserve as much as a single lumen device.

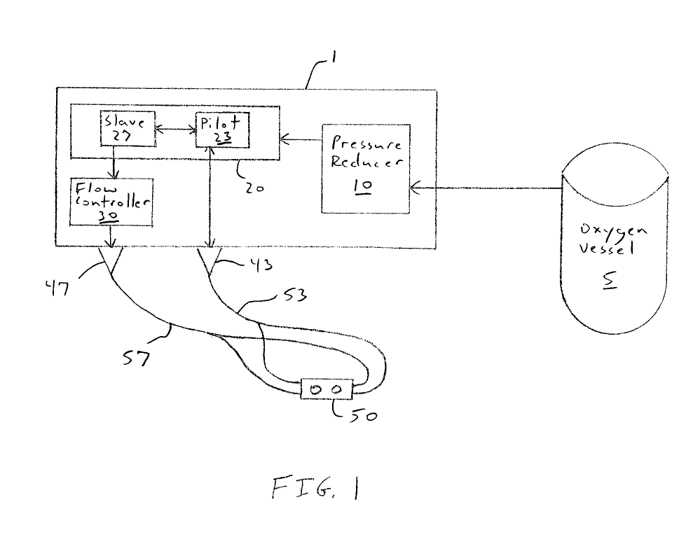

FIG. 1 is a schematic of a typical demand gas regulator system. As shown, the system is a dual-lumen oxygen conserving regulator.

As shown, a housing of an oxygen conserving device 1 is coupled to a compressed oxygen source 5, such as a pressurized vessel. The supplied oxygen is pneumatically coupled through a pressure reducer 10, which reduces the high supply pressure to a lower working pressure, to a demand control system 20, which includes a pilot sub-system 23 and a slave sub-system 27. The pilot sub-system 23 is coupled to a pilot port 43. The slave sub-system delivers gas to a flow controller 30, which regulates a predetermined (e.g. selected) flow rate to a delivery port 47. The patient wears a cannula 50 that connects to the pilot port 43 and the delivery port 47 via respective plastic tubing 53, 57.

At rest, the ports 43, 47 are at atmospheric pressure. When the patient inhales, the pressure at the ports 43, 47 drops. The drop in pressure at the pilot port 43 causes the pilot sub-system 23 to pneumatically communicate with the slave sub-system 27 to release an oxygen flow to the flow controller for delivery to the patient, typically via movement of a pilot and a slave diaphragm that are pneumatically coupled.

It should be understood that embodiments of the invention can include a flow controller of any suitable configuration. The flow controller can simply be a passageway having a specific minimum aperture calculated to deliver a specific flow rate at the working pressure. Rotatable orifice plates can be used to provide an adjustable flow controller. A specific adjustable flow controller is described in U.S. Pat. Nos. 6,053,056 and 6,510,747, the teaching of which are incorporated herein by reference in their entirety. For ease and clarity of the description, further details of the flow controller will be omitted.

After a specific volume of oxygen has flowed to the patient, (or after inhalation has stopped) the pilot sub-system 23 pneumatically communicates with the slave sub-system 27 to halt the oxygen flow. This is usually accomplished by the closing of the pilot diaphragm, which controls the re-pressurization of a timing gas chamber.

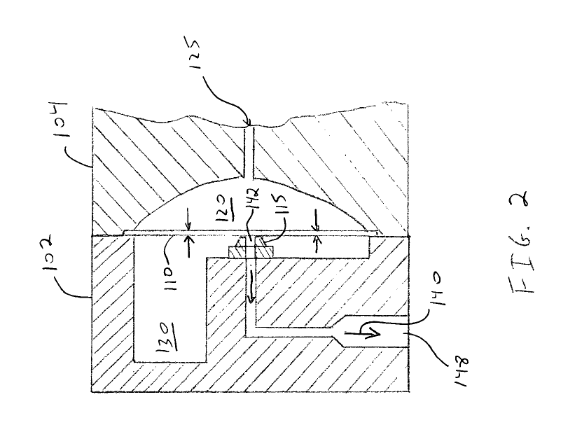

FIG. 2 is a foreshortened cross-sectional schematic of a particular prior art slave valve configuration. As shown, a valve body includes two housing sections 102, 104, which are separated by a slave diaphragm 110. As shown, the slave diaphragm 110 is sealing the entrance to a delivery nozzle 115. The slave diaphragm 110 is held against the head of the delivery nozzle 115 by pressure in a timing gas chamber 120, which is coupled to a pilot diaphragm via a gas conduit 125. Oxygen to be supplied to the patient is stored in a gas reservoir 130. When the slave diaphragm 110 releases, the oxygen flows 140 through the delivery nozzle 115 and the delivery port 148 to the patient. A regulator having this configuration is commercially available from Victor Equipment Company of St. Louis, Mo., and is described in U.S. Pat. No. 6,364,161 to Pryor, the teachings of which are incorporated herein by reference in their entirety.

As understood by those of ordinary skill in the art, the slave (or main) diaphragm 110 is moved by pressure differentials between the chambers 120, 130 on either side of the slave diaphragm. A commercial embodiment has an approximately 15/16″ diameter diaphragm. When pressurized to 22 PSI (36.7 PSIA), 25.32 lbs. of force is exerted on the diaphragm. As discussed above, when a patient inhales, pressure in the timing gas chamber 120 drops. Ideally, this pressure differential will lift the slave diaphragm 110 off the nozzle 115 and gas flows from the gas reservoir 130 through the nozzle 115. When the patient is not inhaling, the opposite happens to seal the nozzle 115.

More particularly, under normal use conditions, the pressure in both chambers 120, 130 is at 22 PSI. The balance of pressure on both sides of the diaphragm prevents it from deforming. When the patient inhales, the pressure in the timing gas chamber 120 drops off and the diaphragm 110 flexes away from the head of the delivery nozzle 115, allowing the oxygen in the gas reservoir 130 to pass into the nozzle 115 and out of the device (eventually through a cannula and into the patient's nose). When the patient stops inhaling, the pressure in the timing gas chamber 120 builds back up and the diaphragm 110 presses against the nozzle 115, stopping the flow of oxygen.

Due to the oxygen flow path 140, when the patient is not inhaling, the surface area of the diaphragm in both chambers 120, 130 subjected to 22 PSI is nearly equal. In fact, the only difference between the surface areas is the surface area of the portion of the nozzle 115 that engages the diaphragm 110 (approximately 0.0017 in.²), which in the gas reservoir 130 will subtract from the overall surface area that is subjected to 22 PSI. When at atmospheric pressure, the force exerted at the nozzle is about 0.025 lbs. Therefore, the force (which is absolute pressure multiplied by surface area) pressing on the diaphragm 110 is nearly equal on both sides of the diaphragm 110. The force exerted on the slave diaphragm 110 by the reservoir 130 (25.26 lbs. at 36.7 PSIA) is only about 0.15% less than the opposing force exerted by the timing chamber 120. The slightest drop in pressure in the timing chamber 120 will cause the diaphragm 10 to lift off the nozzle 115, allowing oxygen to flow through to atmosphere (e.g., up the patient's nose). This is termed balanced pressure.

Under certain conditions when the conserver is not in use, however, it is possible that the gas reservoir 130 is not pressurized. As a result, the slave diaphragm 110 can have 22 PSI of pressure on one side, pressing it against the delivery nozzle 115, while there is essentially no pressure (relative to atmosphere) trying to push the diaphragm away from the nozzle. Depending how the user has turned the unit off, that condition can continue indefinitely. The force created by pressure on one side of the diaphragm over time can eventually deform it. When the user attempts to activate the unit, it will not work properly. Repair entails disassembly of the unit and replacement of the diaphragm 110.

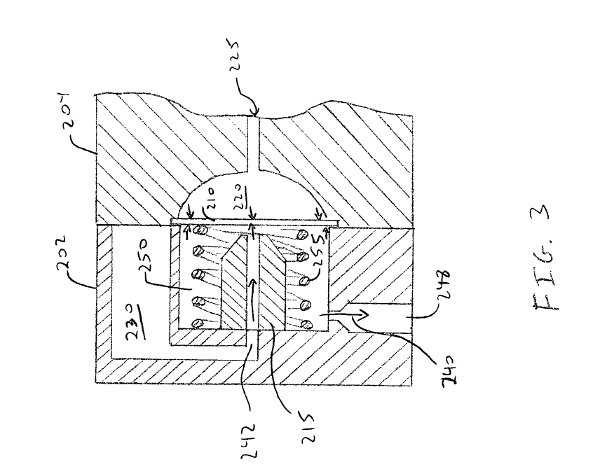

FIG. 3 is a foreshortened cross-sectional schematic of another particular prior art slave valve configuration. In this configuration, the slave diaphragm 210 holds oxygen pressurized to the working pressure in the nozzle 215 when the patient is not inhaling. During inhalation, the diaphragm moves off from the head of the nozzle 215 to deliver oxygen from the nozzle 215 to complete a delivery path 240 to the patient through a delivery chamber 250 and to a delivery port 248.

Due to the oxygen flow path 240, when the patient is not inhaling, the opposing forces on the diaphragm are decidedly unbalanced. In the reservoir 230, the only area with 22 PSI pressing against the diaphragm 210 is a 0.047″ diameter hole through the center of the nozzle 215. The remainder (99.45%) of the surface area of the diaphragm 210 is under the influence of pressure in the delivery chamber 250, which has an outer diameter of 0.625″ and is at atmospheric pressure (0 PSI or 14.7 PSIA). In the timing chamber 220, nearly the entire surface area of the diaphragm 210 is subjected to 22 PSI. Therefore, there is a significant difference between the forces (which is absolute pressure multiplied by surface area) pressing on the diaphragm 210 from different sides of the diaphragm 210. The force ratio of the nozzle force (0.0636 lbs. at 36.7 PSIA) and the delivery chamber force (4.53 lbs. at 14.7 PSIA) versus the timing chamber force (11.25 lbs. at 36.7 PSIA) is about 1:2.45.

Without some assistance, it would take a drop in absolute pressure in the timing chamber 220 approaching atmosphere to cause the diaphragm 210 to lift off the nozzle 215, allowing oxygen to flow to atmosphere. One way to provide the assistance is to use a spring 255, as shown. This technique is used by Nellcor Puritan Bennett Incorporated, of Pleasanton, Calif., and is described in U.S. Pat. No. 6,116,242 to Frye et al., the teachings of which are incorporated herein by reference in their entirety.

Another approach, used in conserving regulators commercially available from Western Medica of Westlake, Ohio, places the nozzle well below the diaphragm, which causes the diaphragm to flex about 1/8 inch to seal the nozzle. In effect, the diaphragm is forced to stretch, thus causing the diaphragm to act as an assisting spring.

Both of those approaches are termed unbalanced pressure with assistance. One disadvantage to both unbalanced pressure approaches is that an additional mechanical feature is used to provide the assistance. Over time, those features can deform or otherwise lose their effectiveness.

One solution is to reduce the pressure in the timing chamber to more nearly balance with the opposing force. One difficulty is that the supply pressure would have to be reduced to two different working pressures. That solution, nevertheless, would bring the timing chamber pressure down to nearly atmospheric pressure, which may be overly sensitive.

Another solution is to increase the force opposing the timing chamber pressure. That can be accomplished by employing a large nozzle.

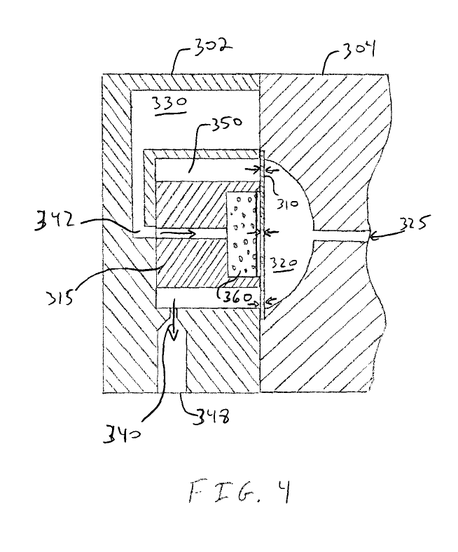

FIG. 4 is a foreshortened cross-sectional schematic of a particular near-balanced demand valve in accordance with the invention. Like in the Puritan Bennett and Western Medica regulators, a slave diaphragm 310 seals the head of a nozzle 315 to prevent pressurized oxygen (at 22 PSI) from escaping out of the nozzle 315 when the patient is not inhaling. The diaphragm has a diameter of about 0.625″. Unlike the prior art, an oversized nozzle 315 having a diameter of about 0.250″ is used. As shown, a filter element 360 is also positioned inside the nozzle, because it was found that a nozzle without a filter tends to make an audible whistle when delivering oxygen to the patient. It is noted that, as shown, the filter element 360 need not interface with the diaphragm.

The filter element 360 is, in particular, a uniform 20 μm filter made of sintered bronze, which can also be useful in filtering certain particulates that may be in the device. Those having ordinary skill in the art will recognize that other filter types and porosities can be used.

During inhalation, the diaphragm moves off from the head of the nozzle 315 (and filter element 360) to deliver oxygen from the nozzle 315 to complete a delivery path 340 to the patient through a delivery chamber 350 and to a delivery port 348.

Due to the oxygen flow path 340, when the patient is not inhaling, the surface area of the diaphragm 310 subjected to 22 PSI has a greater differential than the balanced design, due to the use of an oversize nozzle. As in the Western and Puritan Bennett regulators, on the delivery side, the only area with the working pressure of 22 PSI pressing against the diaphragm 310 is the hole through the center of the nozzle 315. However, the hole through the nozzle 315 is much larger (approximately 0.250″ diameter) than the other designs (approximately 0.047″ diameter). The surface area of the head of the nozzle 315 (0.049 in.²) is thus about 28 times larger than in the prior art.

In the timing chamber 320, nearly the entire surface area of the diaphragm 310 is subjected to 22 PSI. The surface areas subjected to 22 PSI have a differential of approximately 1:6.25 versus a differential of approximately 1:100 in the prior art. Taking the atmospheric forces at work in the delivery chamber 350 into account (i.e. using absolute pressure), the force ratio of the nozzle (1.80 lbs. at 36.7 PSIA) and delivery chamber (3.84 lbs. at 14.7 PSIA) versus the timing chamber (11.25 lbs. at 36.7 PSIA) is about 1:2. This increased force opposing the timing chamber force eliminates the need for assistance in getting the diaphragm 310 to lift off the nozzle 315.

The ratio of the surface areas under 22 PSI on each side of the diaphragm can be altered to control the sensitivity of the device. That is, a larger or smaller nozzle diameter can be employed. Although the ratio of deliver-side forces to timing-side forces should ideally approach 1:1, with the timing-side forces prevailing, such a ratio is not required. A suitable range of ratios is between about 1:1 to over 1:2.

The described embodiment of FIG. 4 offers the following advantages:

The force created on the slave diaphragm 310 by the gas reservoir 330 via the delivery nozzle 315 eliminates the need for springs that will fatigue over time (or using the elasticity of the diaphragm itself as a spring, which can fatigue very quickly). Also, pressure variations in the regulator itself will not affect the balance, because the pressure on each side of the diaphragm 310 is essentially the same.

There is a lower timing gas flow than in the balanced pressure approach.

The balanced pressure approach requires a large diaphragm, which requires a large volume of gas to react and close off the nozzle when the patient stops inhaling. The balanced pressure approach therefore uses a high “timing gas” setting. The timing gas is the gas that refills the timing chamber when the patient stops inhaling. The higher the setting, the faster the conserver reacts. However, by design, timing gas is typically vented to atmosphere—it does not go to the patient. This is wasted oxygen. However, the described solution uses a timing flow of approximately 150-300 cc versus approximately 350 cc for the balanced pressure approach. Unbalanced pressure approaches also use a low timing flow.

The smaller diaphragm 310 is less likely to have deformation or warping problems than those experienced with the large balanced pressure diaphragm. And, failure of the slave diaphragm is a common reason for warranty returns in the prior art systems.

Returning to FIG. 2, it should be apparent that the nozzle 115 can be enlarged such as shown in FIG. 4, including with the porous filter element 360. The larger nozzle can then support the diaphragm so that the diaphragm is less likely to deform or warp in cases where the delivery reservoir is not fully pressurized.

While this invention has been shown and described with references to particular embodiments, those of ordinary skill in the art will recognize that various changes in form and details may be made without departing from the scope of the appended claims. The invention, therefore, is not limited to the described embodiments. In particular, the invention is not limited to oxygen regulators, and the teachings can be applied to any gas-conserving regulator. The invention also is not limited to the specific regulator architectures shown. More generally, the differential pressure valve can be employed with any medium, not just gases. Those and all other equivalents are encompassed by the claims.

What is claimed is:

1. A pneumatic valve, comprising:
a valve body formed to include a delivery passageway between an inlet and an outlet;
a supply reservoir coupled to the inlet; and
a diaphragm valve member movable to open and close the delivery passageway, wherein the interface between the diaphragm and the delivery passageway is substantially greater than 0.55% of the surface area of the diaphragm.

2. The valve of claim 1 wherein substantially greater than 0.55% is about 17%.

3. The valve of claim 1 wherein the delivery passageway includes a nozzle that is sealed by the diaphragm to close the delivery passageway.

4. The valve of claim 1 wherein the delivery passageway includes a filter element at the interface.

5. The valve of claim 4 wherein the filter element has a porosity of about 20 μm.

6. The valve of claim 1 wherein the delivery passageway delivers a gas.

7. A valve, comprising:
a nozzle having a head for delivering a pressurized supply of a medium to a delivery outlet;
a control chamber capable of being pressurized and depressurized; and
a diaphragm disposed between the nozzle head and the control chamber wherein the surface area of the diaphragm communicating with the nozzle head is substantially greater than 0.55% of the surface area of the diaphragm in communication with the control chamber.

8. The valve of claim 7 wherein the nozzle is coupled to a filter element.

9. The valve of claim 8 wherein the filter element has a porosity of about 20 μm.

10. The valve of claim 7 wherein substantially greater than 0.55% is about 17%.

11. The valve of claim 7 wherein the control chamber can be pressurized to at least about 22 PSI.

12. A valve for supplying a flow of a gas, comprising:
a gas reservoir for storing a supply of gas at a delivery pressure;
an outlet for delivering the supply of gas from the gas reservoir;
a nozzle having a head disposed between the gas reservoir and the outlet, the nozzle being pneumatically coupled to the gas reservoir so that gas in the nozzle head is pressurized to the delivery pressure;
a diaphragm for actuating the flow of gas from the nozzle head to the outlet; and
a timing gas chamber for controlling the diaphragm, the diaphragm sealing the nozzle head when the timing gas chamber is pressurized and releasing from the nozzle head when the timing gas chamber is depressurized, wherein the forced exerted on the diaphragm by the pressurized timing gas chamber is substantially balanced by an opposing pneumatic force on the diaphragm.

13. The valve of claim 12 wherein the gas reservoir and the timing gas chamber are pressurized to the delivery pressures.

14. The valve of claim 12 wherein the nozzle head includes a filter element.

15. The valve of claim 14 wherein the filter element has a porosity of about 20 μm.

16. The valve of claim 14 wherein the filter element is fabricated from sintered bronze.

17. The valve of claim 12 wherein substantially balanced comprises having a ratio of the opposing pneumatic force to the timing gas chamber force of less than 1:2.4.

18. The valve of claim 17 wherein the ratio is about 1:2 or less.

19. A gas flow device for delivering a regulated flow of a gas, comprising:
a housing connectable to a source of compressed gas and having an delivery port for delivering a regulated flow of the gas;
a gas flow path within the housing from the source of compressed gas and the delivery port; and
a nozzle disposed in the gas flow path, wherein the nozzle includes a filter element.

20. The gas flow device of claim 19 wherein the filter element is made from sintered bronze.

21. The gas flow device of claim 19 wherein the filter element has a uniform porosity.

22. The gas flow device of claim 19 wherein the gas flow path includes a pneumatic valve, the nozzle forming a part of the valve.

23. A method of making a pneumatic valve, comprising:
forming a valve body to include a delivery passageway between an inlet and an outlet;
coupling a supply reservoir to the inlet; and
positioning a diaphragm valve member movable to open and close the delivery passageway, wherein the interface between the diaphragm and the delivery passageway is substantially greater than 0.55% of the surface area of the diaphragm.

24. A method of making a valve, comprising:
providing a nozzle having a head for delivering a pressurized supply of a medium to a delivery outlet;
forming a control chamber capable of being pressurized and depressurized; and
disposing a diaphragm between the nozzle head and the control chamber wherein the surface area of the diaphragm communicating with the nozzle head is substantially greater than 0.55% of the surface area of the diaphragm in communication with the control chamber.

25. A method of making a valve for supplying a flow of a gas, comprising:
forming a gas reservoir for storing a supply of gas at a delivery pressure;
forming an outlet for delivering the supply of gas from the gas reservoir;
disposing a nozzle having a head between the gas reservoir and the outlet, the nozzle being pneumatically coupled to the gas reservoir so that gas in the nozzle head is pressurized to the delivery pressure;
positioning a diaphragm for actuating the flow of gas from the nozzle head to the outlet; and
forming a timing gas chamber for controlling the diaphragm, the diaphragm sealing the nozzle head when the timing gas chamber is pressurized and releasing from the nozzle head when the timing gas chamber is depressurized, wherein the forced exerted on the diaphragm by the pressurized timing gas chamber is substantially balanced by an opposing pneumatic force on the diaphragm.

26. A method of making a gas flow device for delivering a regulated flow of a gas, comprising:
fabricating a housing connectable to a source of compressed gas and having an delivery port for delivering a regulated flow of the gas;
fabricating a gas flow path within the housing from the source of compressed gas and the delivery port; and
disposing a nozzle in the gas flow path, wherein the nozzle includes a filter element.
